(19) United States
(12) Patent Application Publication
(10) Pub. No.: US 2015/0209734 A1
(43) Pub. Date: Jul. 30, 2015

(54) Molecular Filter

(71) Applicant: Gordon Chiu, Summit, NJ (US)

(72) Inventor: Gordon Chiu, Summit, NJ (US)

(21) Appl. No.: 14/607,147

(22) Filed: Jan. 28, 2015

Related U.S. Application Data
(60) Provisional application No. 61/933,038, filed on Jan. 29, 2014.

(51) Int. Cl. B01D 71/02; B01D 69/12; C02F 1/44

(52) U.S. Cl. CPC B01D 71/024; C02F 1/44; B01D 69/12

(57) ABSTRACT

A molecular filter is provided where the filter comprises of sheets of few layered graphene, few layered oxidized graphene and edge-functionalized graphene oxide. The water molecules are drawn into the filter based on the different hydrophobic and hydrophilic characters of the layers. The water molecule travels through the layers and gaps between the sheets and the direction can be modified based on the arrangement and ratios of the sheet materials.

### PRIORITY

This application claims priority from U.S. Provisional Patent Application No.: 61/933,038, filed on Jan. 29 2014, the contents of which are hereby incorporated by reference.

### FIELD OF THE INVENTION

The present invention relates to a molecular filter and its method of preparation. Specifically, the present invention relates to a molecular filter comprising graphene- and graphene oxide-based compounds.

### BACKGROUND OF THE INVENTION

As the world's population and industry both grow, the need for fresh water increases at least proportionally to that growth. There is an increasing need for fresh water. Potential solutions to this problem are to desalinate sea water as well as purifying water that has been contaminated with pollutants unsuitable for human or animal consumption.

The most commonly used techniques for water filtration include distillation, processes that utilize selective osmosis, ionic processes, and crystallization. However, these processes consume large amounts of energy, resulting in a constant need for new and more economic methods.

Recently, nanomaterials have been used to develop filtering purification technologies.

D. Cohen-Tanugi and J. C. Grossman, “Water desalination across nanoporous graphene,” Nano Lett., 2012, 12 (7), pp. 3602-3608 show that at nanometer scale, pores in single-layered free-standing graphene can filter NaCl particles from aqueous solution from water. The authors show that the water permeability of the graphene filter is several orders of magnitude higher than conventional reverse osmosis membrane. This suggests that nanoporous graphene may serve a valuable role in water purification.

EP 2511002 discloses a graphene-containing separation membrane with enhanced separation efficiency of various materials with a high balance between permeability and selectivity. The publication also discloses use of the separation membrane in sea-water desalination equipment and in gas separation equipment. The graphene separation membrane according to this disclosure includes pores and the size of the pores and channels may be changed for example by changing the graphene growth rate.

U.S. 2012/0255899 discloses a separation membrane including graphene in use for gas separation. The separation membrane is also disclosed in connection with water desalination apparatus. The membrane of this disclosure is a multilayer graphene structure. The membrane includes channels or pores.

US2013/0098833 discloses a nanocomposite semi-permeable membrane for wastewater treatment, seawater desalination, and food and pharmaceutical processing. Among many other nanomaterials, the semi-permeable membrane may include graphite or graphene as well. The nanomaterials are present in a polymer matrix up to about 20 wt-% based on the weight of the polymer-matrix.

U.S. 2013/0256211 discloses a membrane configuration for a filtration or selective fluidic isolation. The configuration contains plane membranes that are constructed from perforated graphene materials. The apertures in the graphene membrane are made by selective oxidation or by laser-drilling.

U.S. Pat. No. 8,361,321 discloses a separation arrangement for isolation of chlorine, sodium and other ions from water. The arrangement comprises at least one perforated graphene sheet with apertures dimensioned to pass water molecules and not to pass the smallest relevant ions.

U.S. 2013/0100436 discloses a molecular filter including a rolled substrate. The rolled substrate may be graphene oxide-based sheets or bio-functionalized graphene.

U.S. 2011/0256376 discloses a laminate sheet including layered graphene oxide sheets and a polymer in spaces between each sheet.

US2012/0107593 discloses graphene oxide membrane materials of high surface area and high electrical conductivity. The membranes according to this disclosure may be of sizes of several thousand micrometers. The graphene oxide sheets of the disclosure are described in connection with a use in biomolecular sensors.

Accordingly there are various solutions for water filtration based on the microporous nature of graphene.

There is a continuous need in various industries for novel methods and materials for water filtration, water purification and water desalination.

### SUMMARY OF THE INVENTION

The present invention provides novel nanomaterials for water filtration and purification.

It is an object of this invention to provide novel economic nanomaterials for water filtration and purification.

It is an object of this invention to provide an efficient molecular filter.

It is an object of this invention to provide a method to provide molecular filters.

It is another object of this invention to provide a molecular filter, comprising one or more sheets of graphene, one or more sheets of graphene oxide and optionally one or more layers of edge-functionalized graphene oxide. Preferably the graphene is few layered Mesograf® and the graphene oxide is Amphioxide™.

It is another object of this invention to provide a molecular filter, comprising one or more sheets of graphene, one or more sheets of graphene oxide and optionally one or more layers of edge-functionalized graphene oxide where the sheets are arranged in one or more stacks and each stack comprises at least few layered graphene and few layered graphene oxide.

It is yet another object of this invention to provide a molecular filter comprising one or more sheets of graphene, one or more sheets of graphene oxide and optionally one or more layers of edge-functionalized graphene oxide, wherein there are gaps between the one or more layers.

It is an object of this invention to provide a molecular filter comprising one or more sheets of graphene, one or more sheets of graphene oxide and optionally one or more layers of edge-functionalized graphene oxide, wherein the ration of graphene and graphene oxide is 1:1.

It is an object of this invention to provide a molecular filter comprising one or more sheets of graphene, one or more sheets of graphene oxide and one or more layers of edge-functionalized graphene oxide, wherein the ration of graphene: graphene oxide:edge functionalized graphene oxide is 2:2:1

It is yet another object of this invention to provide a molecular filter comprising one or more sheets of graphene, one or more sheets of graphene oxide and optionally one or more sheets of edge-functionalized graphene oxide, wherein the filter is covered with fluorinated polymer or the ends of the layers are covered with fluorinated polymer.

It is yet another object of this invention to provide a method to purify and filter water, said method comprising the steps of: a) providing sheets of few layered graphene, few layered graphene oxide and edge-functionalized graphene oxide; b) arranging the sheets in layers, where each layer comprises at least one sheet of graphene, graphene oxide or functionalized graphene oxide; c) allowing water to be drawn into the sheet layer based on hydrophilic and hydrophobic characteristics of the layers; and d) allowing the water molecules to travel through the layers based on the hydrophilic and hydrophobic characteristics of the layers.

### BRIEF DESCRIPTION OF THE DRAWINGS

FIG. 1 shows Raman Spectra of graphite, graphene made with Hummer-method, and of Mesograf®.

FIGS. 2A, 2B, and 2C show different variations of the water filter comprising one or more stacks of nanomaterials sheets.

FIG. 3 shows a variation of the water filter concept where the filter comprises of nanomaterials sheets overlapping each other.

### DETAILED DESCRIPTION OF THE INVENTION

Graphene is one of the crystalline forms of carbon. In graphene, carbon atoms are arranged in a regular hexagonal pattern. Graphene can also be described as a one-atom thick layer of the layered mineral graphite.

Graphene has been synthesized by many methods, including: mechanical exfoliation (“Scotch tape” method), chemical vapor deposition, epitaxial growth, and solution based approaches. Fabrication of large-area graphene is a known challenge because currently, the average size of graphene sheets is 0.5-1 μm².

International patent application publication WO2013/089642 for National University of Singapore discloses a process for forming expanded hexagonal layered minerals and derivatives from raw graphite ore using electrochemical charging. This process includes immersing at least a portion of graphite rock in a slurry comprised of a mixture of expanded graphite, a metal salt, and an organic solvent. This process also includes electrochemically charging the graphite rock by incorporating the graphite rock into at least one electrode and performing electrolysis through the slurry. This is done by via the electrode that is incorporated into the graphite. This electrolysis introduces the organic solvent as well as ions from the metal salt (via the slurry) into the interlayer spacings of the graphite rock to form 1^{st} stage charged graphite that exfoliates from the graphite rock. This process further includes expanding the 1^{st} stage charged graphite by applying an expanding force to increase the spacing between the atomic layers. This process optionally includes the slurry being comprised of the following: 25-65 wt % or 15-20 wt % graphite rock; 0.1-10 wt % or 0.1-5 wt % graphite flake; and an electrolyte, comprising 100-200 g/L or 80-160 g/L of LiClO₄ (5-10 wt %) in propylene carbonate having 40-80 wt % or 70-80 wt %. Mesograf® is large area few layered graphene sheets manufactured by the method disclosed in WO2013/089642.

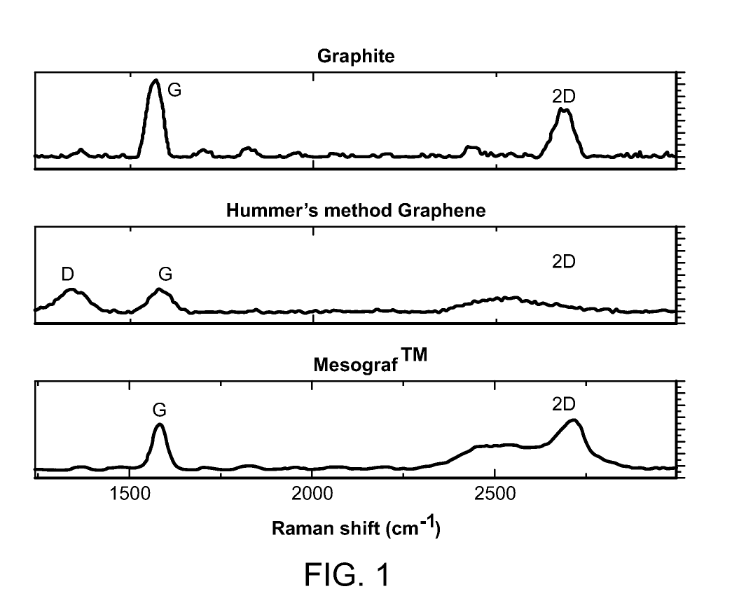

These few layered graphene sheets, made in one step process from graphite ore, have an average area of 300-500 μm². Mesograf® is the preferable few graphene used in this invention and it is obtainable from Graphite Zero Pte. Ltd., Singapore. Mesograf® has extraordinary characters that make it superior to other graphene materials. A Raman spectrum of Mesograf® has almost no D-band as opposed to graphene made by Hummer's method. Raman spectroscopy is commonly used to characterize graphene. The band is typically very weak in graphite, but more pronounced in graphene made via Hummer's method (combining sulfuric acid, sodium nitrate, and potassium permanganate to oxidize graphene). FIG. 1 shows the Raman spectra of graphite, graphene made with Hummer's method, and that of Mesograf®.

Functionalized graphene oxide is preferably made directly from Amphioxide™.

Amphioxide™ is graphene that is at least 20% oxidized and obtained by oxidizing few layered graphene (Mesograf®). Amphioxide™ retains the layer structure of Mesograf®. Graphene oxide, including Amphioxide™ are highly hydrophilic. Amphioxide™ obtainable from Grafoid, Inc., located in Ottawa, Canada, is the preferred graphene oxide of this disclosure. Graphene oxide sheets of the present invention are preferably Amphioxide™ sheets and they have a lateral size of about 100 micrometers. The sheet may have lateral size as large as 200 micrometers.

Graphene is a highly conductive material and it is considered to be a hydrophobic, meaning that it repels water. The few layered graphene (e.g. Mesograf®) is also a highly conductive material, and has hydrophobic properties.

Graphene oxide is a compound of carbon, oxygen and hydrogen in variable rations. Traditionally graphene oxide is obtained by treating graphite with a strong oxidizing agent. Maximally oxidized graphene is yellow solid with carbon: oxygen ratio between 2.1 and 2.0.

Mesograf® Xide is edge-functionalized graphene, and is synthesized using Amphioxide™ as the starting material. Typically this is done by attaching, carbonyl (═CO) and hydroxyl (—OH) groups are attached to both sides and all edges of the few layered graphene oxide. However, in Mesograf® Xide these groups are only located at the edges of the individual layers of the few layered graphene oxide (Amphioxide™). This feature makes the edges of the Mesograf® Xide sheets to be hydrophilic while the surfaces of the sheets are hydrophobic.

Here, a combination material of graphene, graphene oxide and edge-functionalized graphene is disclosed for water filtration. The preferred materials for the filter are Mesograf® as few layered graphene, Amphioxide™ as the graphene and Mesograf® Xide as the edge-functionalized graphene. The combination material disclosed here is an efficient molecular filter. This should be contrasted with all of the previously disclosed graphene filters which incorporate pores imposed on graphene sheets. In the present invention the filtration is based on the movement of the water molecules in between the graphene oxide sheets, as well as the gaps between the stacks, comprising the three materials in varying order. The hydrophobic nature of graphene combined with the amphiphilic and hydrophilic action of graphene oxide and edge-functionalized graphene creates a way to actively draw the water into the structure and to direct the movement of the water molecules within the structure depending the arrangement of the structure's components.

The direction of the movement of water within the filter structure can be defined by providing different ratios and assemblies of the three differently hydrophobic or hydrophilic components or the structure.

An advantage of the water filter and the method in this disclosure as compared to previously known methods or devices is that the different hydrophobic and hydrophilic characteristics of the components the water filter move the water molecules to preferred directions. It should be noted that the movement of the water molecules within the structure is not based on gravity moving the water down through the layers but the water may be directed to move against gravity, it may be directed to move horizontally, downward or in any combinations.

As stated above, this filtering effect is not due to water moving through pores imposed in the sheets. Rather, the filtering effect is due to more complicated movement of the water between the various layers and through the gaps between sheets. Finally, the filter of this invention attracts the water molecules inside it, to specific areas where the filter is comprised of a highly hydrophilic material. Therefore there is no need for outside forces to sift the water through the filter; the hydrophilic materials in filter pull the water in and direct it through the filter due to the assembly of hydrophobic/hydrophilic materials throughout the structure.

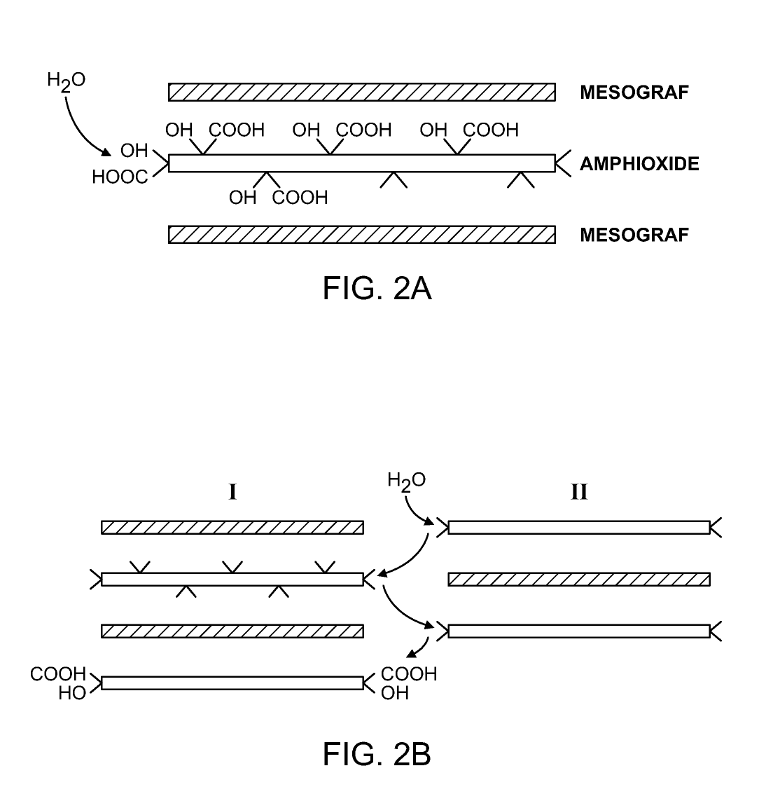

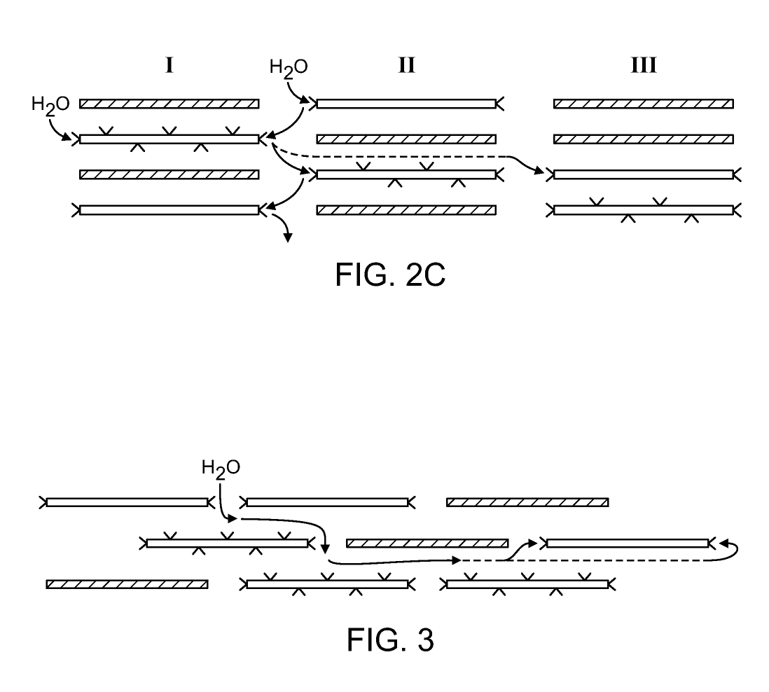

FIGS. 2A, 2B, 2C, and 3 show examples of the structure of various embodiments of the molecular filter and movement of water molecules in different constructions.

In FIG. 2A the structure includes two Mesograf®-sheets (each sheet is a few layered graphene sheet) and an Amphioxide™ sheet (a few layered graphene oxide sheet) in between the Mesograf®-sheets. Due to the carbonyl and hydroxide tails, graphene oxide is hydrophilic and graphene is hydrophobic. For this reason, the water molecules would be drawn in between the Amphioxide™ and Mesograf® sheets.

In FIG. 2B, an embodiment of the present invention is shown where the filter comprises two stacks (I and II). The first stack has two Mesograf® sheets, one Amphioxide™ sheet in between of the Mesograf®- sheets and one Mesograf® Xide sheet next to a Mesograf® sheet. The other stack comprises a Mesograf® Xide sheet on top of a Mesograf® sheet, and a Mesograf® Xide sheet below that. In this embodiment the water molecules are first attracted to the edges of Mesograf® Xide on top of the second stack. From there, the water molecules are then attracted to the Amphioxide™ layer in the first stack. From there, the water molecules are attracted to the edges of the Mesograf® Xide in the second stack, and then to the edges of Mesograf® Xide in the bottom of the first stack. This allows the water molecules to be readily transferred through the gap between the two stacks.

In FIG. 2C, an embodiment of the invention comprising three stacks of Amphioxide™, Mesograf®, and Mesograf® Xide. Here, the water molecule is first attracted to the edges of Mesograf® Xide in the second stack. Then the water molecules are attracted to the Amphioxide™ in the first stack. From there, the water molecules are attracted to the Amphioxide™ in the second stack and after travelling through the Amphioxide™ sheet the molecule would be attracted by the edges of the Mesograf® Xide of the third track and then finally to Amphioxide™ at the bottom of the third stack. This is an example of construction where the molecule travels between the sheets and through the gaps and the direction of the molecule is defined by the arrangement of the sheets. In this particular embodiment, water molecules would travel from up to down and from left to right.

FIGS. 2A, 2B and 2C are illustrative only, and one skilled in the art should understand that any number of stacks and any number of sheets in any order may be used. In the FIGS. 2A, 2B, and 2C the stacks are illustrated as having each layer ending at same point and thereby the gap between the stacks is a straight tunnel. However, it is possible to arrange the layers in the stacks in a way that the tunnel in between of the stacks is not a straight tunnel but where the sheets overlap each other and the between the sheets form various tunnels for the water molecule to pass.

FIG. 3 shows a schematic of one embodiment of the present invention and shows the route of water molecules passing through such a construction. The size of the sheets may vary, which may change the location and orientation of the gaps. Here, the water molecules are first attracted to the edges of Mesograf® Xide on the top layer then to the Amphioxide™ in the middle layer and then through the gap between Amphioxide™ and Mesograf® in the second layer to the Amphioxide™ sheets on the third layer. Thus the water molecule would travel from top to bottom and from left to right.

A skilled artisan understands that there are no limitations to the assembly of the layers and/or stacks. The direction of the movement of water molecule can be freely manipulated by changing the order and ratios of the three different types of sheets.

The layers are so arranged, that the distance between the layers and the stacks is such that the water molecule may enter the space but any contaminating particles or compounds would not get through.

The proportions of the three materials of this invention may be varied depending on the purpose the filter is made. According to one preferred embodiment the ratio of Mesograf® to Amphioxide™ is 1:1. According to another preferred embodiment the ratio of Mesograf® and Amphioxide™ is 1:2. According to one preferred embodiment the ratio of Mesograf® Xide to Mesograf® is 1:2. According to another embodiment the ratio may be 1:4. According to one preferred embodiment the ratio of Mesograf®:Amphioxide™:Mesograf® Xide is 2:2:1. According to one preferred embodiment the ratio is 4:4:1. The skilled artisan understands that the ratios may be changed to any ratio of the three components.

According to one preferred embodiment the Mesograf®: Amphioxide™: Mesograf® Xide-filter may be packed in a fluorinated polymer unit. One suitable example of such a fluorinated polymer is polytetrafluoroethylene, but other fluorinated polymers may as well be used. In particular, this polymer coating would be preferable at the ends of the filter. The purpose of this filter is to trap particles that may be detached from the filter layers. This is why these coating are particularly useful when attached to the ends of the present invention. It seems that during the two to five first passes of the water the filter materials may deteriorate to some degree, similarly as happens with activated carbon filters. In order to trap the graphene particles and prevent them from leaking into the environment, the filter may be packed into a polytetrafluoroethylene coating, the ends of the filter layers may be coated with polytetrafluoroethylene, or polytetrafluoroethylene may be even layered inside the filter. The graphene particles that might deteriorate from the filter layers are about 100 μm large, while polytetrafluoroethylene only allows particles smaller than 5 μm to pass through, which would allow the water pass through but would catch the graphene particles detached from the filter.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A molecular filter, comprising one or more sheets of graphene, one or more sheets of graphene oxide and optionally one or more layers of edge-functionalized graphene oxide.

2. The molecular filter of claim 1, wherein the graphene is few layered graphene obtained by exfoliating from graphite ore, the graphene oxide is few layered graphene oxide and the edge-functionalized graphene oxide is made by directly by modifying the few layered graphene oxide.

3. The molecular filter of claim 1, wherein the sheets are arranged in one or more stacks and each stack comprises at least few layered graphene and few layered graphene oxide.

4. The molecular filter of claim 3, wherein at least one stack comprises edge-functionalized graphene oxide.

5. The molecular filter of claim 4, wherein there is more than one stack and there is a gap between the two stacks.

6. The molecular filter of claim 1, wherein the sheets are arranged in multiple layers and each layer comprises one or more sheets selected from the group containing few layered graphene, few layered graphene oxide and edge-functionalized graphene oxide.

7. The molecular filter of claim 6, wherein there is a gap between one or more sheets in a layer and the gaps in adjacent layers do not coincide with each other.

8. The molecular filter of claim 1, wherein the ratio of graphene and graphene oxide is 1:1.

9. The molecular filter of claim 1, wherein the ratio of graphene: graphene oxide: edge-functionalized graphene oxide is 2:2:1.

10. The molecular filter of claim 1, wherein water molecule travels in between the layers based on hydrophobic and hydrophilic characters of the sheets.

11. The molecular filter of claim 5, wherein the water molecule travels between the sheets and through the gaps based on the hydrophobic and hydrophilic characters of the sheets.

12. The molecular filter of claim 11, wherein the filtration capacity of the filter is determined by the order of the sheets and the width of the gaps.

13. The molecular filter of claim 7, wherein the water molecule travels between the sheets and through the gaps based on the hydrophobic and hydrophilic characters of the sheets.

14. The molecular filter of claim 13, wherein the filtration capacity of the filter is determined by the order of the sheets and the width of the gaps.

15. The molecular filter of claim 1, wherein the filter is covered with fluorinated polymer.

16. The molecular filter of claim 3, wherein the ends of the layers are covered with fluorinated polymer.

17. The molecular filter of claim 6, wherein the ends of the layers are covered with fluorinated polymer.

18. A method to purify and filtrate water, said method comprising the steps of:
a. providing sheets of few layered graphene, few layered graphene oxide and edge-functionalized graphene oxide;
b. arranging the sheets in layers, where each layer comprises at least one sheet of graphene, graphene oxide or edge-functionalized graphene oxide, and wherein the combination of the layers forms a filter;
c. allowing water to be drawn into the sheet layer based on hydrophilic and hydrophobic characteristics of the layers; and
d. allowing the water molecules to travel through the layers based on the hydrophilic and hydrophobic characteristics of the layers.

19. The method of claim 18, wherein there are gaps in between the sheets in each layer and the water molecule in step d) travels through the layers and through the gaps.

20. The method of claim 19, wherein the ratio of graphene: graphene oxide: edge-functionalized graphene oxide is 2:2:1.

21. The method of claim 18, wherein the filter is coated with fluorinated polymer to capture graphene particles detached from the layers during filtration process of steps c) and d).
